(19) United States
(12) Patent Application Publication
(10) Pub. No.: US 2015/0259584 A1
(43) Pub. Date: Sep. 17, 2015

(54) INTEGRATED HEAT SPREADER SEALANTS FOR MICROELECTRONIC PACKAGING

(71) Applicant: Randall D. Lowe, JR., Chandler, AZ (US)

(72) Inventor: Randall D. Lowe, JR., Chandler, AZ (US)

(21) Appl. No.: 14/205,037

(22) Filed: Mar. 11, 2014

(51) Int. Cl. C09J 183/04; G06F 1/20; C08K 5/10; F28F 21/06; C08K 3/36; C08K 3/22

(52) U.S. Cl. CPC C09J 183/04; C08K 3/36; C08K 3/22; C08K 5/10; F28F 21/065; G06F 1/20; C08K 2003/2227

(57) ABSTRACT

Embodiments of the present disclosure describe sealants for use in integrated circuit (IC) package assemblies. Sealants of the present disclosure may have tunable properties including modulus and elongation based on ratios or crosslinker molecules to chain extender molecules present during sealant formation. Other embodiments may be described and/or claimed.

### FIELD

Embodiments of the present disclosure generally relate to the field of integrated circuit package assemblies, and more particularly, to sealants for coupling integrated heat spreaders to package assemblies as well as package assemblies employing the sealants and methods of forming sealants.

### BACKGROUND

As package assemblies become more complicated and incorporate multiple dies in close proximity to one another removing heat from the various elements has become more challenging. As design and complexity of heat spreaders develops to accommodate emerging package arrangements it is becoming necessary to utilize sealants with particular characteristics when mechanically coupling heat spreaders to package assemblies. Traditionally this required reformulation and using different constituents through time consuming and iterative processes to achieve the desired sealant characteristics.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIGS. 1A-B schematically illustrate cross-section side views of a package assembly, in accordance with some embodiments.

FIG. 2 schematically illustrates the structure of a vinyl-terminated polymer resin, in accordance with some embodiments.

FIG. 3 schematically illustrates the structure of a silicone crosslinker molecule, in accordance with some embodiments.

FIG. 4 schematically illustrates the structure of a silyl hydride terminated chain extender molecule, in accordance with some embodiments.

FIGS. 5A-F schematically illustrate example structures of surface wetting agents, in accordance with some embodiments.

FIGS. 6A-E schematically illustrate example structures of adhesion promoters, in accordance with some embodiments.

FIG. 7 schematically illustrates a method of forming a sealant, in accordance with some embodiments.

FIG. 8 schematically illustrates a computing device that includes a sealant as described herein, in accordance with some embodiments.

### DETAILED DESCRIPTION

Embodiments of the present disclosure describe sealants for coupling integrated heat spreaders to integrated circuit (IC) package assemblies. By identifying and controlling the ratio of crosslinker molecules to the chain extending molecules, the properties (in particular elongation and modulus) of the resulting sealant may be easily tuned and adjusted. Thus, using the same base materials in different ratios may result in a number of different sealants having varied characteristics desired for different applications. This may be both faster and less expensive than traditional sealant reformulation and is less likely to result in unwanted changes to other properties.

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials and configurations are set forth in order to provide a thorough understanding of the illustrative implementations. However, it will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” “in embodiments,” or “in some embodiments,” which may each refer to one or more of the same or different embodiments. Furthermore, the terms “comprising,” “including,” “having,” and the like, as used with respect to embodiments of the present disclosure, are synonymous.

The term “coupled with” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

In various embodiments, the phrase “a first feature formed, deposited, or otherwise disposed on a second feature” may mean that the first feature is formed, deposited, or disposed over the second feature, and at least a part of the first feature may be in direct contact (e.g., direct physical and/or electrical contact) or indirect contact (e.g., having one or more other features between the first feature and the second feature) with at least a part of the second feature.

As used herein, the term “module” may refer to, be part of, or include an Application Specific Integrated Circuit (ASIC), an electronic circuit, a system-on-chip (SoC), a processor (shared, dedicated, or group) and/or memory (shared, dedicated, or group) that execute one or more software or firmware programs, a combinational logic circuit, and/or other suitable components that provide the described functionality.

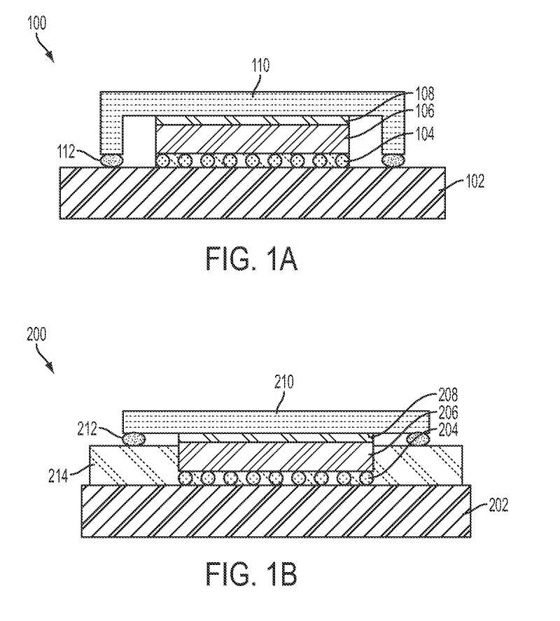

FIG. 1A illustrates a package assembly 100 in accordance with some embodiments. The package assembly 100 includes a die 106, coupled to a substrate 102 via an interconnect 104 (shown as ball grid array (BGA)). A thermal interface material (TIM) 108 may be disposed on the die 106 to thermally couple the die 106 to an integrated heat spreader (IHS) 110. The IHS 110 facilitates the removal of heat from die 106 and may prevent overheating. The TIM 108 facilitates heat removal from the die 106 to the IHS 110 where the heat may be dissipated over a larger area to the environment. TIM 108 may be necessary to maintain sufficient contact (and with it sufficient heat transfer) between die 106 and IHS 110 because the dimensions, and thus relative spacing, of components may vary due to thermal expansion during operation.

IHS 110 may be coupled to substrate 102 via a sealant 112. TIM 108 may provide some level of mechanical coupling between IHS 110 and die 106, but sealant 112 is the primary mechanism for mechanically coupling IHS 110 to the package assembly 100. As discussed below different package assemblies and IHS configuration may necessitate sealants with varying characteristics. In particular, both the elongation and the modulus of the sealant are important. The modulus will determine the strength of the mechanical coupling, while the elongation will determine how the sealant will respond in dissipating stress due to thermally induced dimensional changes. As such, different applications may require sealants with different elongation and modulus values. Typically, this would require the use of different sealants or the reformulation of a sealant for a particular application. Embodiments of the present disclosure include sealants in which the elongation and modulus may be tuned based on ratios of precursor chemicals as opposed to using different chemicals or reformulation. Thus minor changes to constituent ratios during sealant formation may provide sealants with different and desirable characteristics.

FIG. 1B illustrates a package assembly 200 in accordance with some embodiments. Unlike FIG. 1A where the IHS 110 was coupled to the substrate 102, the package assembly 200 may include an IHS 210 coupled to a mold compound 214. Package assembly 200 may include a die 206 coupled to a substrate 202 via an interconnect 204 (shown as a BGA). Similar to package assembly 100, package assembly 200 may also include an IHS 210, which may be thermally coupled to the die 206 via TIM 208. In this arrangement the IHS 210 may be a flat plate, which may be mechanically coupled to the mold compound 214 via a sealant 212. The difference in configurations between package assembly 100 and package assembly 200, as well as the difference in shape between IHS 110 and IHS 210 may result in the sealant 112 requiring different characteristics (i.e. elongation and modulus) as compared with sealant 212. For instance, the mold compound 214 in package assembly 200 may prevent warping due to thermal variation such that a sealant with lower elongation and higher modulus may be beneficial as compared with the arrangement discussed previously regarding package assembly 100. Additionally, the application for which the package assembly is to be used, including foreseeable thermal variation due to operation, reliability testing, and/or environmental factors may further impact the specific requirements for a given sealant.

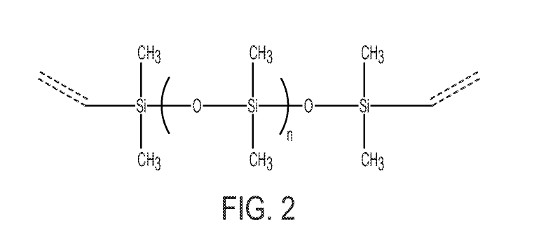

FIG. 2 illustrates the structure of a vinyl-terminated polymer resin, in accordance with some embodiments. The sealant may utilize a vinyl terminated silicone (as shown in FIG. 2) and/or a vinyl terminated silicone-epoxy hybrid polymer resin. The molecular weight of the polymer resin may be varied by varying the value of n, which corresponds to the number of repeating units in a given molecule. Although shown with methyl groups pendant from the silicon (Si) atoms of the repeating unit, other pendant functional groups may also be employed. For instance, longer alkyl chains, aromatic groups as well as functional groups containing non-carbon heteroatoms may be included in place of one or both methyl groups. Furthermore, in the embodiments utilizing vinyl terminated silicone-epoxy hybrid polymer resins, the pendant groups may include epoxide functional groups. Such epoxide functional groups may be tuned to modify intermolecular interactions between polymer chains as well as interactions between polymer chains and treated filler particles. As discussed in more detail below, filler particles may be used to tune certain sealant properties including, but not limited to viscosity. Changes in molecular weight of the polymer resin may also affect sealant viscosity. It is also important to minimize low molecular weight resin that may increase the overall volatile content of the sealant and increase the risk of voiding. By using low-volatile raw materials to form the sealant it may be possible to reduce the risk of sealant voiding. This may be particularly important for rapid curing sealants. Polymer resin molecules may make up from 5% to 25% of the weight of the sealant.

As will be discussed in more detail below the presence of the vinyl functionality at the end of the polymer resin molecules is important to the tunability of the sealant. The vinyl functional groups may react with silyl hydride groups present in the crosslinker and/or chain extender molecules through platinum-catalyzed hydrosilylation to determine the degree of chain extension and cross linking that may occur.

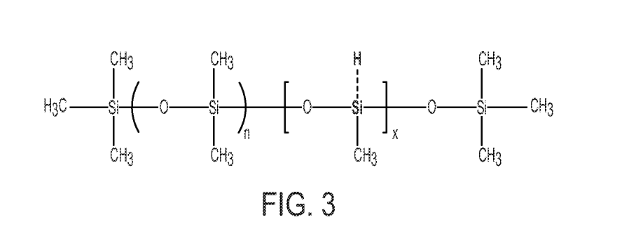

FIG. 3 illustrates the structure of a crosslinker molecule, in accordance with some embodiments. The crosslinker molecules may be silicone or silicone-epoxide based. As discussed above the silyl hydride groups may react with the vinyl functional groups of the polymer resin. As such, the value of x will determine how many polymer resin molecules may be linked via a single crosslinker molecule. In some embodiments each crosslinker molecule may include three silyl hydride groups (x=3), but other arrangements may be used as well. For instance, crosslinker molecules having more than three silyl hydride groups may provide more crosslinking on a per molecule basis. As discussed above the pendant methyl groups on both the n and x repeating units may be interchanged for other functional groups. In some embodiments, silane or epoxide functional groups may be included. These groups may react or interact with the surface of the dies, substrates, integrated heat spreaders etc. to improve adhesion and wetting characteristics. Crosslinker molecules may make up from 0.1% to 5% of the weight of the sealant.

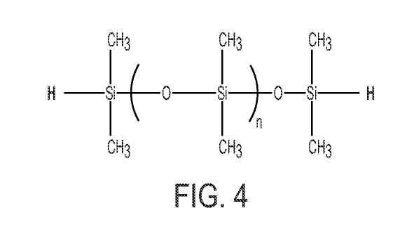

FIG. 4 illustrates the structure of a chain extender molecule, in accordance with some embodiments. The chain extender molecules may include terminal silyl hydride groups. Thus a chain extender molecule may react to connect two polymer resin molecules forming a linear polymer with increased molecular weight. Here again the pendant methyl groups may be replaced by other functional groups as discussed previously to tailor interactions. Also the molecular weight of the chain extender molecules may be varied (by changing n) to tune the viscosity of the sealant. Chain extender molecules may make up from 0.1% to 5% of the weight of the sealant.

Modulus and elongation properties may be tuned by varying the ratio of chain extender molecules to crosslinker molecules. Thus, by working with the same base components, but using different ratios thereof, one may create sealants with varying modulus and elongation values. In general the modulus of the sealants may be between 5 and 50 MPa, but other values may be used in some applications. In some embodiments the ratio of silyl hydride functional groups (associated with crosslinker and chain extender molecules) to vinyl functional groups (associated polymer resin) may be from 0.8 and 1.2. In some embodiments the ratio may approximately 1.0. Maintaining the ratio near 1.0 may prevent additional crosslinking from occurring after the sealant has cured. Such post curing crosslinking may cause unstable sealant properties. That said, the ratio may be varied in some instances to control curing kinetics and providing additional silyl hydride functional groups may increase curing speed.

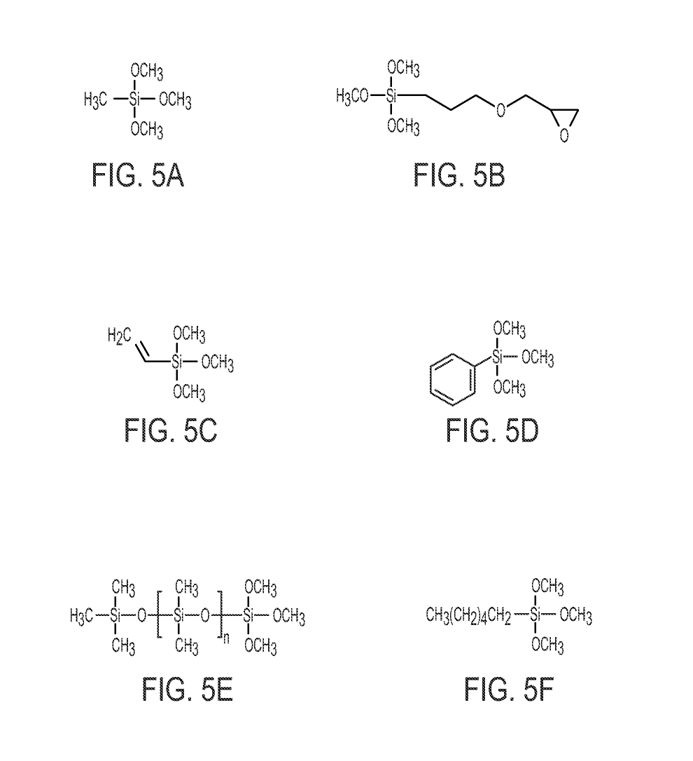

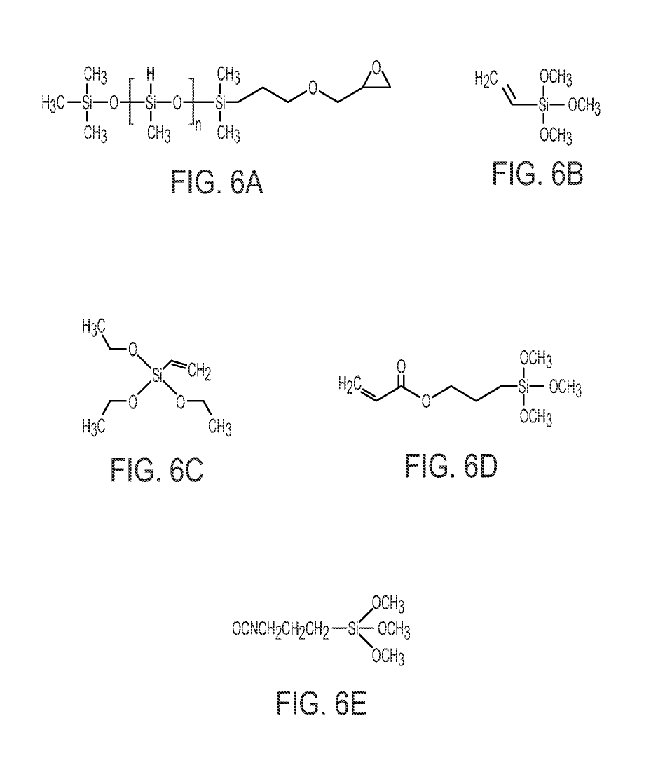

The sealant may also include filler particles. Filler particles may reinforce the sealant and modulate the viscosity, thixotropy, and modulus of the sealant. Filler particles may make up 30% or more of the weight of the sealant. Filler particles may include, but are not limited to, silica, quartz, fumed silica, alumina, silicone, and/or polyester. Filler particles may have average particle diameters from 5-15 μm with maximum particle size less than 100 μm, and preferably less than 50 μm. Fillers having varying particles sizes and shapes may be used. For instance, smaller filler particles will generally increase sealant viscosity whereas larger particles may be used to define minimum bond-line thickness. As discussed below with reference to FIGS. 5-6 the filler particles may be treated to tune their interactions with other components of the sealant.

FIGS. 5A-F illustrate various surface wetting agents that may be included in the sealant. These surface wetting agents may be used to treat the filler particles to ensure uniform dispersion of the filler particles within the sealant. Many different wetting agents may be used and FIGS. 5A-F show some illustrative examples. For instance surface wetting agents may include monomeric, oligomeric, and polymeric chemical agents containing mono, bi, or trifunctional silane groups. The silane groups may include, but are not limited to, chloro, methoxy, ethoxy, isoproxy and acetoxy groups. Surface wetting agents may also include any of the C1-C26 alkylsilanes. In addition to alkylsilanes, the surface wetting agents may include cyclic rings as in phenyltrimethoxysilane and non-carbon heteroatoms as in glycidoxypropyltrimethoxysilane. The filler particles may be treated with the surface wetting agents prior to being incorporated or may be treated in situ during formation of the sealant. Surface wetting agents may make up from 0.1% to 5% of the weight of the sealant.

When possible surface wetting agents having a boiling point above the curing temperature of the sealant should be utilized. This may decrease the volatility of the sealant, especially in instances where an abundance of surface wetting agents are present. If surface wetting agents have a boiling point below the curing temperature of the sealant it is possible that they may vaporize during curing and generate voids in the cured sealant. This may decrease the reliability of the sealant by reducing the interfacial contact area between the sealant and the components it is coupling to one another.

FIGS. 6A-E illustrate various adhesion promoters that may be included in the sealant. The adhesion promoters may improve interfacial adhesion and wetting of the sealant onto the surfaces it contacts. Adhesion promoters may include excess amounts (beyond the amount needed to treat the filler particles) of the surface wetting agents discussed previously. Alternatively, or in addition, adhesion promoters may include molecules configured to form covalent bonds or other interactions between the sealant and the surfaces (IHS, substrate, mold compound etc.) which the sealant contacts. Adhesion promoters may include mono, bi, and trifunctional silanes; thiols, carboxylic acids, and epoxide groups. In addition to the functional groups configured to bond to sealant contact surfaces (IHS, substrate, mold compound etc.), the adhesion promoters may also include functional groups to undergo covalent bonding or other robust intermolecular interactions with the polymer in the sealant. Specific examples of adhesion promoters are shown in FIGS. 6A-E and may include vinyltrimethoxysilane and silyl hydride or vinyl hydride containing PDMS (polydimethylsiloxane) molecules with surface active functional groups such as silane or epoxide groups. In general the adhesion promoters may perform two functions. One is bonding to the sealant contact surfaces and the other is bonding with the polymer portions of the sealant. As discussed previously with regard to the surface wetting agents, the boiling point of the adhesion promoters may be above the curing temperature of the sealant to prevent void formation. Adhesion promoters may make up from 0.1% to 5% of the weight of the sealant.

The sealant may contain additional additives that may make up from 0.1% to 5% of the weight of the sealant. These additional additives may include catalysts, inhibitors, solvents, coloring agents, and other components commonly used in polymer systems to control one or more of bulk properties, reaction mechanics, and final appearance.

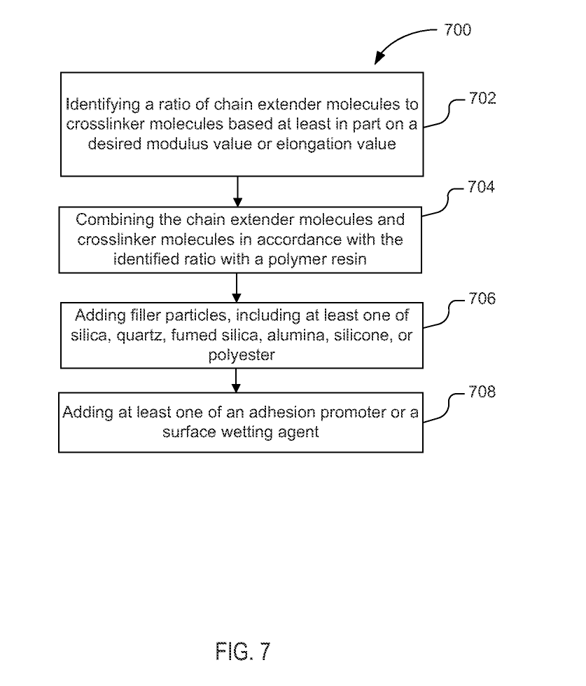

FIG. 7 schematically illustrates a flow diagram of a method 700 for forming a sealant in accordance with some embodiments.

At 702 the method 700 may include identifying a ratio of chain extender molecules to crosslinker molecules based at least in part on a desired modulus value or elongation value. The number of silyl hydride functional groups present in the crosslinker molecules may impact this determination. For instance, crosslinker molecules with more silyl hydride groups may lead to a greater degree of crosslinking on a per molecule basis. This operation may include determining a ratio of silyl hydride functional groups associated with crosslinker molecules as compared to silyl hydride functional groups associated with chain extender molecules.

At 704 the method 700 may include combining the chain extender molecules and crosslinker molecules in accordance with the identified ratio with a polymer resin.

At 706 the method 700 may include adding filler particles including at least one of silica, quartz, fumed silica, alumina, silicone, or polyester. The filler particles may be pretreated with other additives, such as surface wetting agents.

At 708 the method 700 may include adding at least one of an adhesion promoter or a surface wetting agent. As mentioned previously, in some embodiments the filler particles may be treated, as with surface wetting agents, such that the surface wetting agents are added to the filler particles before they are incorporated into the sealant. In some embodiments the adhesion promoter or a surface wetting agent may be added to the sealant during sealant formation. The method 700 may also include the addition of other additives including, but not limited to, catalysts, inhibitors, solvents, coloring agents, and other components commonly used in polymer systems to control one or more of bulk properties, reaction mechanics, and final appearance.

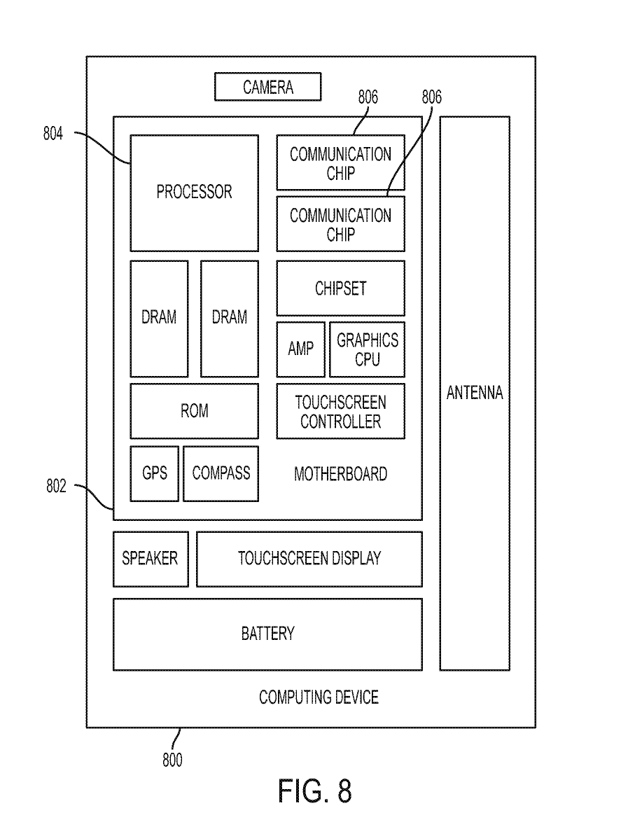

Embodiments of the present disclosure may be implemented into a system using any suitable hardware and/or software to configure as desired. FIG. 8 schematically illustrates a computing device 800 that includes an IC package assembly (e.g., package assemblies 100 or 200 according to FIGS. 1A-B) as described herein, in accordance with some embodiments. The computing device 800 may include housing to house a board such as motherboard 802. Motherboard 802 may include a number of components, including but not limited to processor 804 and at least one communication chip 806. Processor 804 may be physically and electrically coupled to motherboard 802. In some implementations, the at least one communication chip 806 may also be physically and electrically coupled to motherboard 802. In further implementations, communication chip 806 may be part of processor 804.

Depending on its applications, computing device 800 may include other components that may or may not be physically and electrically coupled to motherboard 802. These other components may include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, a Geiger counter, an accelerometer, a gyroscope, a speaker, a camera, and a mass storage device (such as hard disk drive, compact disk (CD), digital versatile disk (DVD), and so forth).

Communication chip 806 may enable wireless communications for the transfer of data to and from computing device 800. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. Communication chip 806 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible BWA networks are generally referred to as WiMAX networks, an acronym that stands for Worldwide Interoperability for Microwave Access, which is a certification mark for products that pass conformity and interoperability tests for the IEEE 802.16 standards. Communication chip 806 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. Communication chip 806 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication chip 806 may operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. Communication chip 806 may operate in accordance with other wireless protocols in other embodiments.

Computing device 800 may include a plurality of communication chips 806. For instance, a first communication chip 806 may be dedicated to shorter range wireless communications such as Wi-Fi and Bluetooth, and a second communication chip 806 may be dedicated to longer range wireless communications such as GPS, EDGE, GPRS, CDMA, WiMAX, LTE, Ev-DO, and others.

Processor 804 of computing device 800 may be packaged in an IC assembly (e.g., package assemblies 100 or 200 according to FIGS. 1A-B) as described herein. For example, processor 804 may correspond with die 106 or 206. The package assembly (e.g., package assemblies 100 or 200 according to FIGS. 1A-B) and motherboard 802 may be coupled together using package-level interconnects such as BGA balls. The term “processor” may refer to any device or portion of a device that processes electronic data from registers and/or memory to transform that electronic data into other electronic data that may be stored in registers and/or memory.

Communication chip 806 may also include a die that may be packaged in an IC assembly (e.g., package assemblies 100 or 200 according to FIGS. 1A-B) as described herein. In further implementations, another component (e.g., memory device or other integrated circuit device) housed within computing device 800 may include a die that may be packaged in an IC assembly (e.g., package assemblies 100 or 200 according to FIGS. 1A-B) as described herein.

In various implementations, computing device 800 may be a laptop, a netbook, a notebook, an ultrabook™, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the computing device 800 may be any other electronic device that processes data.

Various operations are described as multiple discrete operations in turn, in a manner that is most helpful in understanding the claimed subject matter. However, the order of description should not be construed as to imply that these operations are necessarily order dependent.

### EXAMPLES

Some non-limiting examples are provided below.

Example 1 includes a sealant for bonding package assembly components, the sealant comprising: at least 5% by weight vinyl-terminated polymer resin; from 0.1% to 5% by weight chain extender molecules including terminal silyl hydride functional groups; and from 0.1% to 5% by weight crosslinker molecules including at least three silyl hydride functional groups.

Example 2 includes the sealant of example 1, wherein the vinyl-terminated polymer resin includes at least one of a vinyl-terminated silicone or a vinyl-terminated silicone-epoxy hybrid.

Example 3 includes the sealant of example 1, further comprising: from 0.1% to 5% by weight surface wetting agent molecules including functional silane groups and having a boiling point above a curing temperature of the sealant.

Example 4 includes the sealant of example 1, further comprising: from 0.1% to 5% by weight adhesion promoting molecules including at least a first functional group to interact with a surface of a substrate or heat spreader, at least a second functional group to interact with the vinyl-terminated polymer resin, and having a boiling point above a curing temperature of the sealant.

Example 5 includes the sealant of example 1, further comprising: at least 30% by weight filler particles including at least one of silica, quartz, fumed silica, alumina, silicone, or polyester.

Example 6 includes the sealant of any of examples 1-5, wherein: the crosslinker molecules include at least one additional functional group to interact with a surface of a substrate or heat spreader.

Example 7 includes the sealant of example 6, wherein: the additional functional group is a silane or epoxide functional group.

Example 8 includes the sealant of any of examples 1-5, wherein: the chain extender molecules include at least one additional functional group to interact with a surface of a substrate or heat spreader.

Example 9 includes the sealant of any of examples 1-5, wherein: the ratio of vinyl functional groups to silyl hydride functional groups is from 0.8 to 1.2.

Example 10 includes a package assembly comprising: a die; an integrated heat spreader thermally coupled to the die; at least one of a mold compound or a substrate; and a sealant to mechanically couple the integrated heat spreader to the at least one of a mold compound or a substrate; wherein the sealant comprises a crosslinked polymer including: at least 5% by weight polymer resin molecules coupled to one another at terminal locations by at least one of chain extender molecules coupled at terminal locations to two polymer resin molecules or crosslinker molecules coupled at non-terminal locations to at least three polymer resin molecules; wherein the chain extender molecules and the crosslinker molecules each form up to 5% by weight of the sealant.

Example 11 includes the package assembly of example 10, wherein the polymer resin includes at least one of a silicone or a silicone-epoxy hybrid.

Example 12 includes the package assembly of example 10, wherein: at least one of the chain extender molecules or the crosslinker molecules include at least one additional functional group to interact with a surface of a substrate or heat spreader.

Example 13 includes the package assembly of example 10, wherein: the ratio of polymer resin molecule terminal locations to polymer resin coupling locations associated with the chain extender molecules and the crosslinking molecules is from 0.8 to 1.2.

Example 14 includes the package assembly of any of examples 10-13, wherein the sealant further comprises at least 30% by weight filler particles including at least one of silica, quartz, fumed silica, alumina, silicone, or polyester.

Example 15 includes the package assembly of any of examples 10-13, wherein the sealant further comprises at least one of an adhesion promoter or a surface wetting agent and the at least one of an adhesion promoter or a surface wetting agent has a boiling point above a curing temperature of the sealant.

Example 16 includes a method of making a sealant for bonding package assembly components, the method comprising: identifying a ratio of chain extender molecules including terminal silyl hydride functional groups to crosslinker molecules including at least three silyl hydride functional groups based at least in part on a desired modulus value or elongation value; and combining the chain extender molecules and crosslinker molecules in accordance with the identified ratio with a vinyl-terminated polymer resin.

Example 17 includes the method of example 16, further comprising: adding filler particles, including at least one of silica, quartz, fumed silica, alumina, silicone, or polyester, to at least one of the chain extender molecules, the crosslinker molecules, or the vinyl-terminated polymer resin.

Example 18 includes the method of example 16, wherein identifying the ratio of chain extender molecules to crosslinker molecules comprises identifying a ratio of silyl hydride functional groups associated with the chain extender molecules to silyl hydride functional groups associated with the crosslinker molecules.

Example 19 includes the method of example 16, further comprising: adding at least one of an adhesion promoter or a surface wetting agent; wherein the least one of an adhesion promoter or a surface wetting agent has a boiling point above a curing temperature of the sealant.

Example 20 includes the method of any of examples 16-19, wherein: the vinyl-terminated polymer resin is from 5% to 25% of the total weight of the sealant.

Example 21 includes the method of any of examples 16-19, wherein: at least one of the crosslinker molecules or the chain extender molecules include at least one additional functional group to interact with a surface of a substrate or heat spreader.

Example 22 includes a computing device comprising: a circuit board; and a package assembly coupled with the circuit board, the package assembly including a die; an integrated heat spreader thermally coupled to the die; at least one of a mold compound or a substrate; and a sealant to mechanically couple the integrated heat spreader to the at least one of a mold compound or a substrate; wherein the sealant comprises a crosslinked polymer including: at least 5% by weight polymer resin molecules coupled to one another at terminal locations by at least one of chain extender molecules coupled at terminal locations to two polymer resin molecules or crosslinker molecules coupled at non-terminal locations to at least three polymer resin molecules; wherein the chain extender molecules and the crosslinker molecules each form up to 5% by weight of the sealant.

Example 23 includes the computing device of example 22, the sealant further comprising at least one of an adhesion promoter or a surface wetting agent and the at least one of an adhesion promoter or a surface wetting agent has a boiling point above a curing temperature of the sealant.

Example 24 includes the computing device of examples 22-23, wherein: the ratio of polymer resin molecule terminal locations to polymer resin coupling locations associated with the chain extender molecules and the crosslinking molecules is from 0.8 to 1.2.

Example 25 includes the computing device of any of examples 22-23, wherein: the computing device is a mobile computing device including one or more of an antenna, a display, a touchscreen display, a touchscreen controller, a battery, an audio codec, a video codec, a power amplifier, a global positioning system (GPS) device, a compass, a Geiger counter, an accelerometer, a gyroscope, a speaker, or a camera coupled with the circuit board.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated implementations, including what is described in the Abstract, is not intended to be exhaustive or to limit the embodiments of the present disclosure to the precise forms disclosed. While specific implementations and examples are described herein for illustrative purposes, various equivalent modifications are possible within the scope of the present disclosure, as those skilled in the relevant art will recognize.

These modifications may be made to embodiments of the present disclosure in light of the above detailed description. The terms used in the following claims should not be construed to limit various embodiments of the present disclosure to the specific implementations disclosed in the specification and the claims. Rather, the scope is to be determined entirely by the following claims, which are to be construed in accordance with established doctrines of claim interpretation.

What is claimed is:

1. A sealant for bonding package assembly components, the sealant comprising:
at least 5% by weight vinyl-terminated polymer resin;
chain extender molecules including terminal silyl hydride functional groups; and
crosslinker molecules including at least three silyl hydride functional groups;
wherein the chain extender molecules and the crosslinker molecules each form up to 5% by weight of the sealant.

2. The sealant of claim 1, wherein the vinyl-terminated polymer resin includes at least one of a vinyl-terminated silicone or a vinyl-terminated silicone-epoxy hybrid.

3. The sealant of claim 1, further comprising:
surface wetting agent molecules including functional silane groups and having a boiling point above a curing temperature of the sealant;
wherein the surface wetting agent molecules form up to 5% by weight of the sealant.

4. The sealant of claim 1, further comprising:
adhesion promoting molecules including at least a first functional group to interact with a surface of a substrate or heat spreader, at least a second functional group to interact with the vinyl-terminated polymer resin, and having a boiling point above a curing temperature of the sealant;
wherein the adhesion promoting molecules form up to 5% by weight of the sealant.

5. The sealant of claim 1, further comprising: at least 30% by weight filler particles including at least one of silica, quartz, fumed silica, alumina, silicone, or polyester.

6. The sealant of claim 1, wherein:
the crosslinker molecules include at least one additional functional group to interact with a surface of a substrate or heat spreader.

7. The sealant of claim 6, wherein:
the additional functional group is a silane or epoxide functional group.

8. The sealant of claim 1, wherein:
the chain extender molecules include at least one additional functional group to interact with a surface of a substrate or heat spreader.

9. The sealant of claim 1, wherein:
the ratio of vinyl functional groups to silyl hydride functional groups is from 0.8 to 1.2.

10. A package assembly comprising:
a die;
an integrated heat spreader thermally coupled to the die;
at least one of a mold compound or a substrate; and
a sealant to mechanically couple the integrated heat spreader to the at least one of a mold compound or a substrate;
wherein the sealant comprises a crosslinked polymer including:
at least 5% by weight polymer resin molecules coupled to one another at terminal locations by at least one of chain extender molecules coupled at terminal locations to two polymer resin molecules or crosslinker molecules coupled at non-terminal locations to at least three polymer resin molecules;
wherein the chain extender molecules and the crosslinker molecules each form up to 5% by weight of the sealant.

11. The package assembly of claim 10, wherein the polymer resin includes at least one of a silicone or a silicone-epoxy hybrid.

12. The package assembly of claim 10, wherein:
at least one of the chain extender molecules or the crosslinker molecules include at least one additional functional group to interact with a surface of a substrate or heat spreader.

13. The package assembly of claim 10, wherein:
the ratio of polymer resin molecule terminal locations to polymer resin coupling locations associated with the chain extender molecules and the crosslinking molecules is from 0.8 to 1.2.

14. The package assembly of claim 10, wherein the sealant further comprises at least 30% by weight filler particles including at least one of silica, quartz, fumed silica, alumina, silicone, or polyester.

15. The package assembly of claim 10, wherein the sealant further comprises at least one of an adhesion promoter or a surface wetting agent and the at least one of an adhesion promoter or a surface wetting agent has a boiling point above a curing temperature of the sealant.

16. A method of making a sealant for bonding package assembly components, the method comprising:
identifying a ratio of chain extender molecules including terminal silyl hydride functional groups to crosslinker molecules including at least three silyl hydride functional groups based at least in part on a desired modulus value or elongation value; and
combining the chain extender molecules and crosslinker molecules in accordance with the identified ratio with a vinyl-terminated polymer resin.

17. The method of claim 16, further comprising:
adding filler particles, including at least one of silica, quartz, fumed silica, alumina, silicone, or polyester, to at least one of the chain extender molecules, the crosslinker molecules, or the vinyl-terminated polymer resin.

18. The method of claim 16, wherein identifying the ratio of chain extender molecules to crosslinker molecules comprises identifying a ratio of silyl hydride functional groups associated with the chain extender molecules to silyl hydride functional groups associated with the crosslinker molecules.

19. The method of claim 16, further comprising:
adding at least one of an adhesion promoter or a surface wetting agent;
wherein the least one of an adhesion promoter or a surface wetting agent has a boiling point above a curing temperature of the sealant.

20. The method of claim 16, wherein:
the vinyl-terminated polymer resin is from 5% to 25% of the total weight of the sealant.

21. The method of claim 16, wherein:
at least one of the crosslinker molecules or the chain extender molecules include at least one additional functional group to interact with a surface of a substrate or heat spreader.

22. A computing device comprising:
a circuit board; and
a package assembly coupled with the circuit board, the package assembly including
a die;
an integrated heat spreader thermally coupled to the die;
at least one of a mold compound or a substrate; and
a sealant to mechanically couple the integrated heat spreader to the at least one of a mold compound or a substrate;
wherein the sealant comprises a crosslinked polymer including:
at least 5% by weight polymer resin molecules coupled to one another at terminal locations by at least one of chain extender molecules coupled at terminal locations to two polymer resin molecules or crosslinker molecules coupled at non-terminal locations to at least three polymer resin molecules;
wherein the chain extender molecules and the crosslinker molecules each form up to 5% by weight of the sealant.

23. The computing device of claim 22, the sealant further comprising at least one of an adhesion promoter or a surface wetting agent and the at least one of an adhesion promoter or a surface wetting agent has a boiling point above a curing temperature of the sealant.

24. The computing device of claim 22, wherein:
the ratio of polymer resin molecule terminal locations to polymer resin coupling locations associated with the chain extender molecules and the crosslinking molecules is from 0.8 to 1.2.

25. The computing device of claim 22, wherein:
the computing device is a mobile computing device including one or more of an antenna, a display, a touchscreen display, a touchscreen controller, a battery, an audio codec, a video codec, a power amplifier, a global positioning system (GPS) device, a compass, a Geiger counter, an accelerometer, a gyroscope, a speaker, or a camera coupled with the circuit board.
